(19) United States
(12) Patent Application Publication
(10) Pub. No.: US 2007/0135325 A1
(43) Pub. Date: Jun. 14, 2007

(54) Composition for thinning and cleanup of paint

(76) Inventors: Charles L. Hawes, Cordova, TN (US); Dennis E. Shireman, Marion, AR (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/299,070

(22) Filed: Dec. 10, 2005

(51) Int. Cl. C23D 17/00; C11D 17/00; C11D 17/08

(52) U.S. Cl. 510/407; 134/38; 510/417

(57) ABSTRACT

A composition and related process for the thinning and cleanup of paint, wherein the composition is a solvent external emulsion and comprises an organic solvent, a surfactant and water.

### TECHNICAL FIELD

The present invention relates to a composition for thinning paint and for paint cleanup. In a more specific aspect, this invention relates to a paint thinning and cleanup composition which is in the form of an emulsion. This invention also relates to a process for thinning paint and for the cleanup of paint.

In this application, the term “paint” will be understood to refer to pigmented coatings such as epoxies, enamels, latexes, primers, basecoats, oil based paints, varnishes and polyurethane finishes which are used to protect and/or beautify substrates. As used in this application, the terms “paint thinning”, “paint thinner” and similar terms refer to compositions which reduce the viscosity of paint. Also, as used in this application, the term “paint cleanup” and similar terms refer to the dissolving and dispersing of paint from a substrate.

In this application, the term “emulsion” will be understood to refer to a suspension of small globules or droplets of a liquid in a second liquid in which the globules are not soluble. The emulsion of this application is a macroemulsion and can be described as solvent external, in which the liquid globules (sometimes referred to as the internal phase) are suspended in a second or surrounding liquid (external phase).

### BACKGROUND OF THE INVENTION

Compositions for paint thinning and cleanup are well-known in the industry, and many types of compositions exist for these particular uses.

Mineral spirits, a hydrocarbon solvent derived from crude oil, is perhaps the most commonly used paint thinner, especially for oil-based paint. Mineral spirits is also commonly used in paint cleanup for the tools and other surfaces used in painting with oil-based paint. Because of its direct relation to crude oil, mineral spirits is subject to fluctuations in the price of crude oil, such fluctuations often being upward.

Additionally, as local, state and federal governments require stricter controls on the amount of volatile organic compounds and combustible chemicals which can be used, the compositions used to thin and cleanup paint often must be changed to comply with those controls.

Another commonly used paint thinner is turpentine. However, in contrast to turpentine, mineral spirits leaves no gummy residue, does not tend to deteriorate with age and is generally cheaper.

However, paint thinner and cleanup compositions which are predominantly or entirely composed of mineral spirits or turpentine may create safety concerns, as these two materials are highly combustible.

Biodegradability may also be a concern for current paint thinner and cleanup compositions which are predominantly or entirely composed of mineral spirits or turpentine.

In addition, when working with paint thinner and cleanup compositions, the user must also be concerned about the disposal of hazardous substances and the use of non-renewable resources. These two concerns are becoming more important as environmental issues become more significant.

The prior art contains many disclosures of compositions and methods which can be used to reduce the viscosity of certain compositions. For example, Bostrom et al. U.S. Pat. No. 6,150,445 discloses a composition and method for use in reducing the viscosity of an aqueous concentrate.

Sau U.S. Pat. No. 6,900,255 discloses a composition and method for suppressing (i.e., reducing) the viscosity in film forming coatings, such as latex paints.

In addition to disclosures in regard to viscosity reduction, the prior art discloses the use of emulsions in various industries. For example, Mulqueen et al. U.S. Pat. No. 6,074,986 discloses a composition and method for the preparation of emulsions in the cosmetic, pharmaceutical, food, photographic, paint and polymer industries.

Another disadvantage or undesirable result with prior art paint thinners is their tendency to adversely affect the color and/or gloss of the paint, which can be evident after the thinned paint is applied to a substrate.

Thus, for various reasons, the paint thinner and cleanup compositions of the prior art do not achieve the desired results in many situations.

Therefore, there is a need in the industry for a paint thinner and cleanup composition which eliminates or minimizes the disadvantages or problems encountered with the prior art compositions.

### SUMMARY OF THE INVENTION

The present invention provides an improved composition for thinning paint and for paint cleanup. As compared to the compositions of the prior art as described above, the composition of this invention is cost effective, contains less volatile organic compounds, does not adversely affect the color or gloss of the paint being thinned and reduces concerns in regard to safety, hazardous waste disposal and renewal of resources.

The present invention also provides a process for thinning and cleanup of paint.

Briefly described, the present invention provides a new and improved composition which is a solvent external emulsion and which contains a hydrocarbon solvent, a surfactant and water. Each component is used in a defined weight percent range, based on the total weight of the composition.

Accordingly, an object of this invention is to provide a composition for thinning paint and for cleanup of paint.

Another object of this invention is to provide a paint thinner and cleanup composition which contains a low amount of volatile organic compounds.

Another object of this invention is to provide a paint thinner and cleanup composition which provides less fuel to burn.

Another object of this invention is to provide a paint thinner and cleanup composition which provides less hazardous waste for disposal.

Another object of this invention is to provide a paint thinner composition which does not adversely affect the color or gloss of the paint.

Another object of this invention is to provide a paint thinner and cleanup composition which is a solvent external emulsion.

Still another object of this invention is to provide a process for thinning and cleanup of paint.

Still another object of this invention is to provide a process for thinning and cleanup of paint with a composition which is a solvent external emulsion.

These and other objects, features and advantages of the present invention will become apparent from the following description.

### DETAILED DESCRIPTION OF THE INVENTION

The present invention provides a composition, in the form of a solvent external emulsion, for thinning paint and for paint cleanup, wherein the composition comprises a an organic solvent, a surfactant and water. The present invention also provides a process by which the above-defined emulsion can be effectively used to thin and cleanup paint.

As defined above, there are certain essential components in the composition of this invention. These components and their corresponding weight percent ranges are shown below, with the weight percents being based on the total weight of the composition.

| Component | Weight Percent Range |
|---|---|
| Organic Solvent | about 16.0 to about 90.0 |
| | (preferably about 30.0 to about 75.0) |
| Surfactant | about 0.01 to about 10.0 |
| | (preferably about 0.05 to about 5.0) |
| Water | about 20.0 to about 75.0 |
| | (preferably about 45.0 to about 70.0) |

If these components are used in amounts outside these ranges, the composition may provide results which do not meet the user's objectives for thinning and/or cleanup of paint.

Optional components may be added to the composition of this invention to achieve other objectives. Examples of these optional components are preservatives, colorants, evaporation retardants, humectants, anti-settling agents, pigments, bittering agents, pH adjusting agents, etc. These optional components can be used in the amounts necessary to achieve desired results.

In this invention, the organic solvent functions as the primary thinning component. Examples of suitable organic solvents are aliphatic, aromatic and terpene hydrocarbons; halogenated solvents; esters and di-ester solvents; and mixtures of such organic solvents. The preferred organic solvent is mineral spirits.

Examples of suitable aliphatic and aromatic hydrocarbon solvents include mineral spirits, kerosene, naptha, xylene and mineral seal oil. Examples of suitable terpene hydrocarbon solvents include d-limonene, dipentene and turpentine. Examples of suitable halogenated solvents include methylene chloride and 1-chloro-4-trifluoromethyl benzene. Examples of suitable esters and di-ester solvents include methyl oleate and dimethyl glutarate.

The surfactant functions as a stabilizer to produce the emulsion and then to prevent separation of the emulsion into various components. Examples of suitable surfactants are nonionic surfactants, anionic surfactants, cationic surfactants, amphoteric surfactants and mixtures of such surfactants. The surfactant or surfactant mixture should be mixable in the solvent or solvent mixture and have an average HLB less than 8 and preferably less than 5.

Examples of suitable nonionic surfactants are:
alkoxylated alkyl phenols;
alkoxylated alcohols;
amines;
amides;
alkoxylated amides;
alkoxylated amines;
alkoxylated fatty acids;
alkoxylated thioethers;
glycerol esters;
sorbitan and alkoxylated sorbitan esters;
polygluconates;
silicone surfactants;
polymeric nonionic surfactants; and
ethylene oxide/propylene oxide block copolymers.

Examples of suitable cationic surfactants are:
alkyl trimethylammonium chlorides and bromides having from 12 to 22 carbon atoms and alkoxylated derivatives thereof;
dialkyl dimethylammonium chlorides and bromides having from 12 to 22 carbon atoms and alkoxylated derivatives thereof;
alkyl amine hydrochlorides and hydrobromides;
sulfates and sulfonates having from 12 to 22 carbon atoms and alkoxylated derivates thereof.

Examples of suitable anionic surfactants are:
acids and salts of alkyl sulfates and alkyl ether sulfates having from 12 to 30 carbon atoms;
acids and salts of alkylbenzene sulfonates having from 12 to 30 carbon atoms;
acids and salts of alkyldiphenyl oxides, sulfonates and disulfonates having from 12 to 30 carbon atoms;
acids and salts of alkyl naphthalene sulfonates having from 12 to 30 carbon atoms;
acids and salts of alkane or olefin sulfonates having from 10 to 20 carbon atoms;
acids and salts of ester sulfonates having from 12 to 20 carbon atoms;
acids and salts or various half salts of alkyl sulfosuccinates;
acids and salts of sulfobetaines;
acids and salts of phosphate esters;
acids and salts of saturated and unsaturated fatty acids having from 10 to 24 carbon atoms;
acids and salts of taurates and isothionates having from 12 to 24 carbon atoms.

Example of suitable amphoteric surfactants are:
amine oxides and betaines having from 10 to 20 carbon atoms;
alkyl imidazolines and imidazoline derivatives having from 10 to 24 carbon atoms;
acids and salts of alkylpropionates having from 10 to 24 carbon atoms;
acids and salts of alpha and beta alkyl aminoacid derivatives having from 10 to 24 carbon atoms;
alkyl substituted nitrogen heterocyclics having from 10 to 24 carbon atoms.

The water used in the composition of this invention can be distilled, soft, hard, tap, potable and non-potable water. Mixtures of such waters can be used.

The present invention is further illustrated by the following examples which are designed to teach those of ordinary skill in the art how to practice this invention and to represent the best mode contemplated for carrying out this invention.

Procedure

The following emulsions were prepared using techniques and process steps which are well known in the industry, such as low, medium and high shear dispersing or homogenization.

### EXAMPLE 1

| Component | Weight Percent |
|---|---|
| Mineral Spirits | 35.0 |
| Propylene Glyrol | 1.0 |
| Tall Oil Fatty Acid | 0.375 |
| 5 Mole Ethoxylated Cocoamine | 0.5 |
| Water | 63.125 |
| | 100.00 |

### EXAMPLE 2

| Component | Weight Percent |
|---|---|
| Mineral Spirits | 35.0 |
| Hypermer 2234 (a polymeric emulsifier) | 1.0 |
| Water | 64.00 |
| | 100.00 |

### EXAMPLE 3

| Component | Weight Percent |
|---|---|
| Mineral Spirits | 35.0 |
| Tall Oil Fatty Acid | 0.5 |
| 5 Mole Ethoxylated Cocoamine | 0.375 |
| Propylene Glycol | 1.0 |
| Sodium Chloride | 0.25 |
| Water | 62.875 |
| | 100.00 |

### EXAMPLE 4

| Component | Weight Percent |
|---|---|
| Aromatic 150 Solvent | 35.0 |
| Tall Oil Fatty Acid | 0.375 |
| 5 Mole Ethoxylated Cocoamine | 0.5 |
| Propylene Glycol | 1.0 |
| Sodium Chloride | 0.25 |
| Water | 62.875 |
| | 100.00 |

### EXAMPLE 5

| Component | Weight Percent |
|---|---|
| d-Limonene | 35.0 |
| 5 Mole Ethoxylated Cocoamine | 0.46 |
| Tall Oil Fatty Acid | 0.375 |
| Water | 64.165 |
| | 100.00 |

### EXAMPLE 6

| Component | Weight Percent |
|---|---|
| Mineral Spirits | 35.0 |
| Oleic Acid Amide | 0.75 |
| Water | 64.25 |
| | 100.00 |

### EXAMPLE 7

| Component | Weight Percent |
|---|---|
| Mineral Spirits | 50.0 |
| Tall Oil Fatty Acid | 0.375 |
| 5 Mole Ethoxylated Cocoamine | 0.5 |
| Water | 49.125 |
| | 100.00 |

### EXAMPLE 8

| Component | Weight Percent |
|---|---|
| Mineral Spirits | 35.0 |
| Dodecylbenzene Sulfonic Acid | 0.5 |
| Sodium Chloride | 0.25 |
| Dodecyldimethylamine | 0.375 |
| Water | 63.875 |
| | 100.00 |

### EXAMPLE 9

| Component | Weight Percent |
|---|---|
| Mineral Spirits | 35.0 |
| Silsurf J208-812 (a silicone glycol copolymer) | 0.75 |
| Water | 64.25 |
| | 100.00 |

### EXAMPLE 10

| Component | Weight Percent |
|---|---|
| Mineral Spirits | 35.0 |
| Oleyl Hydroxyethylimidazoline | 0.75 |
| Water | 64.25 |
| | 100.00 |

| Component | Weight Percent |
|---|---|
| Mineral Spirits | 20.0 |
| Oleyl Hydroxyethylimidazoline | 0.75 |
| Water | 79.25 |
| | 100.00 |

These compositions were tested for their ability to thin paint. Each composition provided good results, as shown below.

Thinning tests were conducted on GLIDDEN Ultra Hide oil/alkyd/semi gloss interior/exterior paint using a Ford #4 Cup, and results were expressed in time in seconds to drain.
Paint Only=446 seconds
Example 1=215 seconds
Example 2=188 seconds
Example 3=183 seconds
Example 4=148 seconds
Example 5=183 seconds
Example 6=193 seconds
Example 7=134 seconds
Example 8=185 seconds
Example 9=212 seconds
Example 10=227 seconds

The composition of Example 10 was used to thin the commercially available paints identified below, and the thinned paints were then tested for gloss retention. The results show that these thinned paints had a gloss retention which is improved or equivalent to the gloss retention when these same paints were thinned with the same amount of mineral spirits. The results show the GARDNER Micro Tri Gloss 60° readings after the thinned paints are allowed to dry.

| Paint | 10% Mineral Spirits | 10% Example 10 |
|---|---|---|
| FARRELL Calhoun | 89.77 | 88.56 |
| Ford blue | | |
| GLIDDEN Ultra Hide | 87.13 | 90.6 |
| crimson red | | |
| GLIDDEN Ultra Hide | 74.63 | 78.43 |
| green | | |
| SHERWIN WILLIAMS | 73.23 | 78.23 |
| Enamel green | | |
| SHERWIN WILLIAMS | 83.13 | 85.8 |
| Enamel safety red | | |

The solvent external emulsion compositions of this invention are highly effective in thinning oil based alkyd paints and in the cleanup of oil based alkyd and latex paints.

By using less solvent than conventional paint thinning and cleanup compositions, the solvent external compositions of this invention provide several advantages when compared to such conventional compositions:
In regard to safety—furnishes less fuel to burn if a fire should occur; and
In regard to disposal—provides less hazardous waste for disposal;

The present invention has been described in detail with particular reference to certain embodiments, but variations and modifications can be made without departing from the spirit and scope of the invention as defined in the following claims.

What is claimed is:

1. A solvent external emulsion composition for thinning and cleanup of paint, wherein the composition comprises:
A. an organic solvent;
B. a surfactant; and
C. water.

2. A composition as defined by claim 1 wherein the organic solvent is an aliphatic hydrocarbon, aromatic hydrocarbon, terpene hydrocarbon or a mixture thereof.

3. A composition as defined by claim 1 wherein the organic solvent is a halogenated solvent.

4. A composition as defined by claim 1 wherein the organic solvent is an ester or di-ester solvent.

5. A composition as defined by claim 1 wherein the organic solvent is mineral spirits, kerosene, naptha, xylene or mineral seal oil.

6. A composition as defined by claim 1 wherein the organic solvent is d-limonene.

7. A composition as defined by claim 1 wherein the hydrocarbon organic solvent is mineral spirits.

8. A composition as defined by claim 1 wherein the surfactant is a nonionic, anionic, cationic or amphoteric surfactant or a mixture thereof.

9. A composition as defined by claim 1 wherein the surfactant is a mixture of tall oil fatty acid and 5 mole ethoxylated cocoamine.

10. A composition as defined by claim 1 wherein the surfactant is 5 mole ethoxylated cocoamine.

11. A composition as defined by claim 1 wherein the surfactant is oleic acid amide.

12. A composition as defined by claim 1 wherein the surfactant is oleyl hydroxyethylimidazoline.

13. A composition as defined by claim 1 wherein the surfactant is a mixture of dodecydimethylamine and dodecylbenzene sulfonic acid.

14. A composition as defined by claim 1 wherein the water is distilled water.

15. A solvent external emulsion composition for thinning and cleanup of paint, wherein the composition comprises:
A. from about 16.0 to about 90.0 percent by weight of an organic solvent;
B. from about 0.01 to about 10.0 percent by weight of a surfactant; and
C. from about 20.0 to about 75.0 percent by weight of water.

16. A process for thinning of paint, wherein the process comprises mixing paint and a solvent external emulsion composition which comprises:
A. an organic solvent;
B. a surfactant; and
C. water.

17. A process as defined by claim 16 wherein the organic solvent is mineral spirits.

18. A process as defined by claim 16 wherein the organic solvent is d-limonene.

19. A process for thinning of paint, wherein the process comprises mixing paint and a solvent external emulsion composition which comprises:
A. from about 16.0 to about 90.0 percent by weight of an organic solvent;
B. from about 0.01 to about 10.0 percent by weight of a surfactant; and
C. from about 20.0 to about 75.0 percent by weight of water.

20. A process for cleanup of paint, wherein the process comprises dissolving and dispersing of paint with a solvent external emulsion composition which comprises:
A. an organic solvent;
B. a surfactant; and
C. water.

21. A process as defined by claim 20 wherein the organic solvent is mineral spirits.

22. A process as defined by claim 20 wherein the organic solvent is d-limonene.

23. A process for cleanup of paint, wherein the process comprises dissolving and dispersing of paint with a solvent external emulsion composition which comprises:
A. from about 16.0 to about 90.0 percent by weight of an organic solvent;
B. from about 0.01 to about 10.0 percent by weight of a surfactant; and
C. from about 20.0 to about 75.0 percent by weight of water.
